(19) United States
(12) Patent Application Publication
(10) Pub. No.: US 2008/0095099 A1
(43) Pub. Date: Apr. 24, 2008

(54) Apparatus, system and method adapted to filter out redundant TCP ACKs in wireless networks

(76) Inventors: Alex Kesselman, Hafia (IL); Boris Ginzburg, Haifa (IL)

Correspondence Address: INTEL CORPORATION;c/o INTELLEVATE, LLC, P.O. BOX 52050, MINNEAPOLIS, MN, 55402, US

(21) Appl. No.: 11/583,201

(22) Filed: Oct. 18, 2006

(51) Int. Cl. H04Q 7/00

(52) U.S. Cl. 370/328

(57) ABSTRACT

An embodiment of the present invention provides an apparatus, comprising a transmitter operable in a wireless local area network and adapted to filter out redundant TCP ACK-s. In an embodiment of the present invention the apparatus may further comprise when a TCP ACK with a given sequence number arrives to a wireless link sending queue, a comparison may be made to other TCP ACK-s of the same connection and those with sequence numbers less than the given sequence number may be dropped from this queue.

### BACKGROUND

Wireless networks, such as wireless local area networks (WLAN) have become pervasive in daily living and vital for wireless communication. There is a constant and crucial need to improve these wireless networks. In WLANs, Transmission Control Protocol Acknowledgements (TCP ACK-s) may collide with data packets and may have redundancy, thereby causing decreased performance in a wireless network. The most popular technique used to reduce collisions of TCP ACK-s with data packets in wireless links is Delayed TCP Acknowledgments (DTA). This technique allows sending out one cumulative ACK after receiving a pre-defined number K of packets (usually K=2). Unfortunately, DTA requires reconfiguration of the TCP receiver, which may not be possible if a mobile station uploads data to an external server. Further, for a large K, DTA may adversely affect TCP ACK-s clocking mechanism since TCP send events are triggered by ACK-s.

Another proposal is a TCP-aware link layer solution that keeps track of TCP data and ACK packets received at the base station and implements TCP ACK-s and data filters to forward packets to both connection endpoints. However, this approach needs to maintain a per-connection state.

Thus, a strong need exists for an apparatus, system and method adapted to filter out redundant TCP ACK-s in wireless networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts components in a basic wireless local area network of one embodiment of the present invention; and

FIG. 2 illustrates a flowchart of the method according to one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software. as in a cause and effect relationship).

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

An embodiment of the present invention provides a new method for acceleration of Transmission Control Protocol/Internet Protocol (TCP/IP) over wireless local area networks, such as, but not limited to, the Institute for Electronic and Electrical Engineers 802.11 standard for WLANs, based on filtering of redundant TCP ACK-s on L2 level, in the transmit buffer of a transmitter of TCP ACK-s.

Bidirectional TCP traffic works well for wired networks because most of links are full-duplex. However, in wireless networks, TCP ACK-s contend with data packets for channel access. As a result, the overall throughput of a TCP connection is significantly reduced. TCP returns an acknowledgement (ACK) for each data packet, and the sender retransmits lost packets to guarantee reliable delivery. TCP assigns a sequence number to each byte transmitted and the acknowledgment mechanism is cumulative, that is an acknowledgment of sequence number seqno (see algorithm below) indicates that all bytes up to but not including seqno have been received. Acknowledgments with the same sequence numbers are used by TCP for packet loss indication. TCP traffic is bursty by nature and typically a TCP receiver sends a bunch of acknowledgments with increasing sequence numbers over a short period of time, which may end up in a wireless link layer sending queue.

In an embodiment of the present invention is provided a novel method for TCP Acceleration. The present invention is unique in that it may analyze and remove redundant TCP ACK-s from the TX buffer in wireless driver/embedded firmware (L2 level). When a TCP ACK with a sequence number X arrives to the wireless link sending queue, drop from this queue all TCP ACK-s of the same connection with sequence numbers less than X (the comparison takes into account wrap-around of sequence numbers). The proposed algorithm may be described by the following pseudo-code, although it is understood that this pseudo-code is merely one illustrative example and the present invention is not limited to any particular pseudo-code or algorithm:

```
SendFilter(p, TxBUF) { // send a packet p over wireless link from
the transmit buffer TxBUF
    If (p is TCP ACK and p is not piggybacked) {
        Conn = connection(p); // get the TCP connection of p
        For each TCP ACK p′ in TxBUF that belongs to Conn {
            // check whether the TCP sequence number of p′ is less
            than that of p
            If (SEQ_LESS(ACK_NUM(p′), ACK_NUM(p′))) {
                Drop(p′); // the queued ACK is dropped
            }
        }
    }
    Continue with the regular send flow of p;
}
```

By removing redundant TCP ACK-s, the proposed algorithm alleviates the ACK-s contention problem, and improves the overall throughput. Moreover, the algorithm of one embodiment of the present invention may be stateless and thus amenable to efficient hardware implementation.

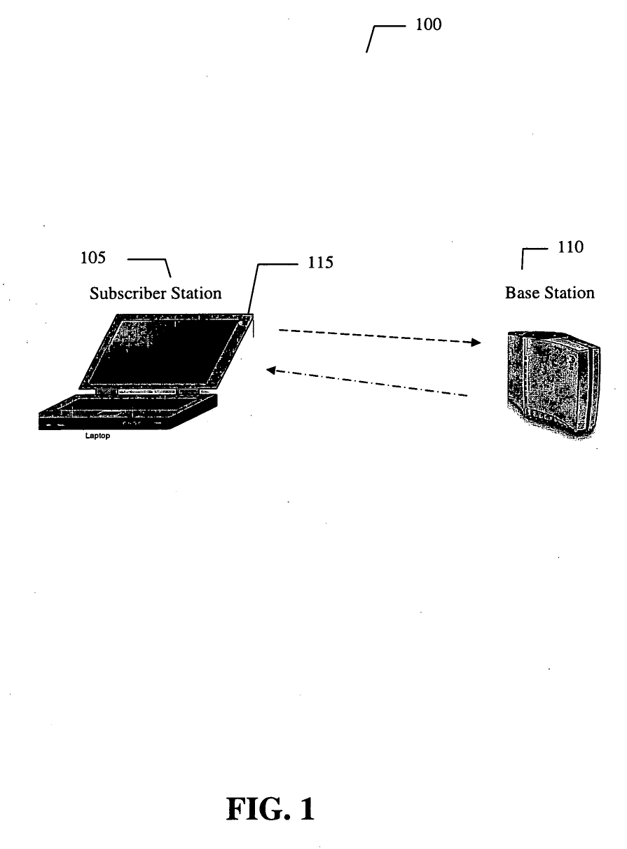

Turning now to the figures, FIG. 1, shown generally as 100 illustrates the basic components that may be included in a WLAN of one embodiment of the present invention. These may include base station 110 subscriber (also referred to as access point) in communication with subscriber (also referred to as mobile) station 105, wherein the communication for such may include the method adapted to filter out redundant TCP ACK-s in wireless networks of the present invention. Subscriber station 105 may include antenna 115.

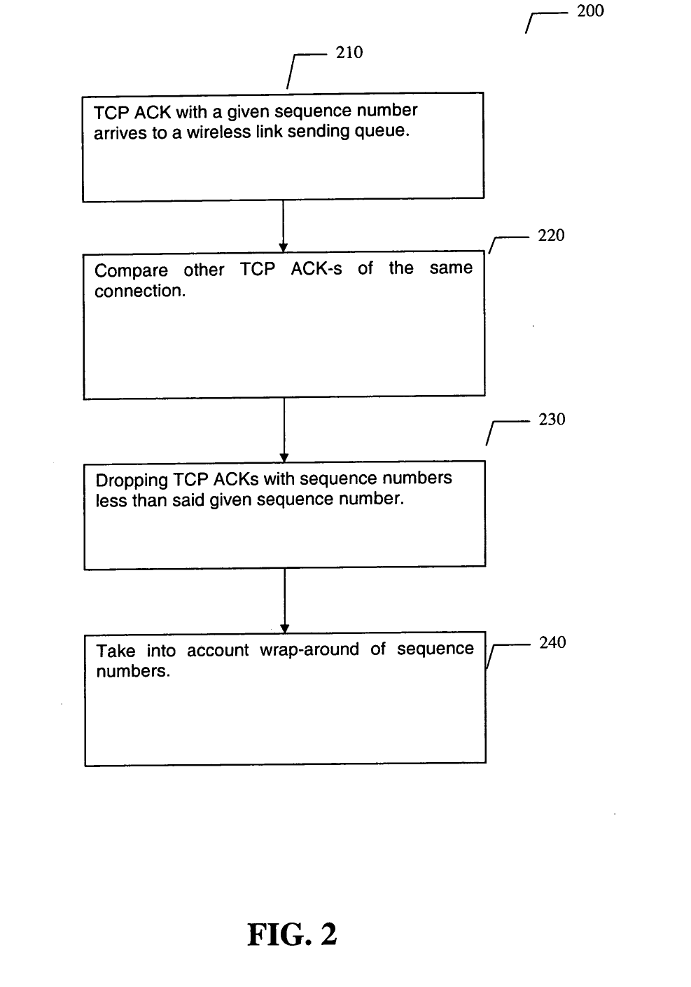

A method of one embodiment of the present invention is shown in FIG. 2 generally at 200. The method may include filtering out redundant TCP ACK-s from transmissions in a wireless local area network. When a TCP ACK with a given sequence number arrives to a wireless link sending queue 210, it is compared with other TCP ACK-s of the same connection 220 and TCP ACK-s with sequence numbers less than said given sequence number 230 are dropped. In an embodiment of the present invention, a comparison taking into account wrap-around of sequence numbers 240 is provided.

In another exemplary embodiment of the present invention is provided a machine-accessible medium that provides instructions, which when accessed, cause a machine to perform operations comprising filtering out redundant TCP ACK-s from transmissions in a wireless local area network (WLAN). Further instructions may cause the machine to perform operations further comprising filtering the redundant TCP ACK-s at the L2 level in the transmit buffer of the transmitter and when a TCP ACK with a given sequence number arrives to a wireless link sending queue, comparing other TCP ACK-s of the same connection and dropping TCP ACK-s with sequence numbers less than the given sequence number.

Yet another exemplary embodiment of the present invention provides a system 200, comprising a subscriber station 105 including a receiver operable in a wireless local area network; and a transmitter in communication with the receiver which may be located in a base station 10, the transmitter may be adapted to analyze and remove redundant TCP ACK-s from a transmit buffer in the wireless driver/embedded firmware of the transmitter prior to transmissions to the receiver.

The system of one embodiment of the present invention may further comprise when a TCP ACK with a given sequence number arrives to a wireless link sending queue, a comparison may be made and other TCP ACK-s of the same connection and sequence numbers less than the given sequence number are dropped from this queue.

In yet another exemplary embodiment of the present invention where each ACK carries just the last contiguously received sequence number, it may also be extended to work with a TCP Selective Acknowledgment (SACK) strategy, which improves TCP behavior in the face of multiple dropped segments.

With TCP SACK, the data receiver may inform the sender about all segments that have arrived successfully, so that the sender needs to retransmit only the segments that have actually been lost. Each segment is a block of contiguous sequence space:

Left Edge of Block—This is the first sequence number of this block.

Right Edge of Block—This is the sequence number immediately following the last sequence number of this block.

In order to apply the present invention to TCP SACK, an extra check is performed that the newly arriving TCP ACK acknowledges ALL the segments in the TCP ACK under consideration in the TX buffer before dropping it.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

We claim:

1. An apparatus, comprising:
a transmitter operable in a wireless network and adapted to filter out redundant TCP ACK-s.

2. The apparatus of claim 1, wherein said wireless network is a wireless local area network (WLAN).

3. The apparatus of claim 2, wherein filtering of said redundant TCP ACK-s occurs at the L2 level in the transmit buffer of said transmitter.

4. The apparatus of claim 1, further comprising when a TCP ACK with a given sequence number arrives to a wireless link sending queue, a comparison is made to other TCP ACK-s of the same connection and sequence numbers less than said given sequence number are dropped from this queue.

5. The apparatus of claim 4, wherein said comparison takes into account wrap-around of sequence numbers.

6. A method, comprising:
filtering out redundant TCP ACK-s from transmissions in a wireless network.

7. The method of claim 6, wherein said wireless network is a wireless local area network (WLAN).

8. The method of claim 7, further comprising filtering said redundant TCP ACK-s at the L2 level in the transmit buffer of said transmitter.

9. The method of claim 6, further comprising when a TCP ACK with a given sequence number arrives to a wireless link sending queue, comparing other TCP ACK-s of the same connection and dropping TCP ACK-s with sequence numbers less than said given sequence number.

10. The method of claim 9, further comprising said comparison taking into account wrap-around of sequence numbers.

11. A machine-accessible medium that provides instructions, which when accessed, cause a machine to perform operations comprising:
filtering out redundant TCP ACK-s from transmissions in a wireless local area network (WLAN).

12. The machine-accessible medium of claim 11, further comprising said instructions causing said machine to perform operations further comprising filtering said redundant TCP ACK-s at the L2 level in the transmit buffer of said transmitter.

13. The machine-accessible medium of claim 11, further comprising said instructions causing said machine to perform operations further comprising when a TCP ACK with a given sequence number arrives to a wireless link sending queue, comparing other TCP ACK-s of the same connection and dropping TCP ACK-s with sequence numbers less than said given sequence number.

14. The machine-accessible medium of claim 11, further comprising said instructions causing said machine to perform operations further comprising said comparison taking into account wrap-around of sequence numbers.

15. A system, comprising:
a mobile station with a receiver operable in a wireless local area network; and
a base station with a transmitter in communication with said receiver, said transmitter adapted to analyze and remove redundant TCP ACK-s from a transmit buffer in the wireless driver/embedded firmware of said transmitter prior to transmissions to said receiver.

16. The system of claim 15, further comprising when a TCP ACK with a given sequence number arrives to a wireless link sending queue, a comparison is made and other TCP ACK-s of the same connection and sequence numbers less than said given sequence number are dropped from this queue.

17. The system of claim 16, wherein said comparison takes into account wrap-around of sequence numbers.

18. The apparatus of claim 4, wherein an extra check is performed that any newly arriving TCP ACK acknowledges ALL the segments in a TCP ACK under consideration in a TX buffer before dropping it.
